(19) United States
(12) Patent Application Publication
(10) Pub. No.: US 2004/0038006 A1
(43) Pub. Date: Feb. 26, 2004

(54) Method and device for producing paper material in the form of a multiple-layer sheet and product obtained in this way

(76) Inventor: Guglielmo Biagiotti, Lucca (IT)

Correspondence Address: Breiner & Breiner, 115 North Henry Street, PO Box 19290, Alexandria, VA, 22320-0290, US

(21) Appl. No.: 10/416,806

(22) PCT Filed: Nov. 19, 2001
(86) PCT No.: PCT/IT01/00581

(30) Foreign Application Priority Data
Nov. 22, 2000 (IT) FI2000A000238

(51) Int. Cl. B32B 3/00; B31F 1/00; B31F 1/20; B31F 1/07

(52) U.S. Cl. 428/172; 156/291; 156/205; 156/209; 156/462; 156/470; 156/553

(57) ABSTRACT

In one embodiment, the device comprises: a counter-acting cylinder (1) provided with a plurality of points (1P) and interacting with an adhesive dispenser (7), a pressure roller (3) and a laminating roller (5); the points on the counter-acting cylinder have a density and dimensions such that the technical and functional and/or aesthetic characteristics of the web material are not appreciably altered, and such that the two layers (V₁, V₂) are joined by means of the adhesive applied by said dispensing roller at the positions of the points.

### TECHNICAL FIELD

The present invention relates to a method for producing a multiple-layer paper web material.

The invention also relates to a device for producing a multiple-layer paper web material, and to a multiple-layer paper product, for example a tissue paper product.

### STATE OF THE ART

In the paper converting industry, it is frequently necessary to produce articles formed from two or more layers of paper which are joined and bond together. For example, in the production of toilet paper, kitchen paper for domestic use, paper towels and the like, two or more layers are joined to form a sheet material made of so-called “tissue” paper. The joining is frequently carried out by applying adhesive to one or both of the layers which are to form the finished product. In other cases, the joining is carried out mechanically, by a process known as “ply-bonding”. This process is frequently used for joining non-embossed or micro-embossed layers, in the production of toilet paper.

WO-A-9944814 describes devices and processes for producing a multiple-layer paper material. In one of the possible configurations described therein, the device comprises an embossing cylinder provided with points according to an embossing pattern, interacting with rubber-covered pressure rollers. A first layer is run around the embossing cylinder provided with points, and is pressed against it by a first pressure roller to emboss the layer. An adhesive is applied to the protuberances thus formed on the first layer, to enable the second layer to be bonded. A second pressure roller presses the two layers against each other on the points with which the embossing cylinder is provided.

According to this known art, the end product is provided with the embossing pattern to which the adhesive is applied.

### OBJECTS AND SUMMARY OF THE INVENTION

The object of the present invention is to provide a new method and a new device for producing paper articles made from multiple-layer sheet, particularly tissue paper.

According to a first aspect of the invention, a method is provided for producing a multiple-layer paper web material, comprising the steps of: applying an adhesive to at least a first layer by passing said first layer between a counter-acting cylinder and an adhesive dispensing roller; placing next to said first layer at least a second layer in contact with the adhesive applied to the first layer; and laminating the first layer and the second layer together to join them by means of the adhesive. Characteristically, according to the invention, the adhesive is applied in areas at the positions of points with which the counter-acting cylinder or the adhesive dispensing roller is provided. The density and dimensions of the points are such that sufficient adhesion is provided between said two layers, but are also such that the technical and functional and/or aesthetic characteristics of the web material which is produced are not appreciably altered with respect to the characteristics of the material before the gluing.

By contrast with conventional methods, therefore, the points (whether located on the counter-acting cylinder or on the adhesive dispensing roller) are used, not to emboss the paper material in a visible way, with consequent alteration of the aesthetic and/or technical and functional aspect of the material, but rather to delimit the points of application of the adhesive.

In practice, in order to achieve this result, the areas of application of the adhesive (delimited by the points) can advantageously be made to occupy a surface area not exceeding 5% of the total surface area of the web material. Preferably, the surface area occupied by the adhesive will be equal to or less than 2% of the total surface area of the article, and preferably more than 1%.

In practice, the points can have a density of, for example, not more than 2 points per cm², and, in a practical embodiment, each of them can have a surface of contact with the layer (in other words an end surface) whose area is not greater than 1.2 mm².

In a first embodiment of the invention, the method provides for the use of a counter-acting cylinder having a cylindrical surface provided with said points, and a pressure roller which interacts with the counter-acting cylinder to slightly deform at least the first layer between the pressure roller and the counter-acting cylinder upstream from the adhesive dispensing roller.

In practice, the degree of deformation is such that it is essentially invisible to the naked eye (if the product is viewed from a normal viewing distance, for example 20-30 cm) when the web material moves away from the counter-acting cylinder. Thus the end product does not have protuberances in the areas of application of the adhesive.

The first layer is deformed by the points on the embossing cylinder, which penetrate into the layer until the deformed areas are made to project, for example by 0.02 to 0.3 mm, and preferably by 0.05 to 0.15 mm. With a projection of this size, it is possible to apply the adhesive by means of the dispensing roller in such a way that the adhesive is limited to the projecting areas of the layer, in other words the areas in contact with the points on the counter-acting cylinder.

It is possible to have the first and/or the second layer pre-embossed before they are subjected to gluing. In this case, it is advantageous to have the pre-embossing consist of a set of protuberances having simple geometrical shapes, with a high density and small dimensions, typically with a density of more than 15 protuberances per cm² and preferably more than 30 protuberances per cm². The application of the adhesive to very widely spaced points of small dimensions according to the method of the present invention causes the gluing points to be practically invisible and concealed in the embossing pattern of the layers.

In a different embodiment of the present invention, the points for the application of the adhesive are formed on the adhesive dispensing roller. In this case, the counter-acting cylinder is preferably smooth. In this way, as will be made clear by the following description of some embodiments, it is possible to produce articles formed from smooth layers joined by adhesive distributed at certain points without any embossing of the layers. In this case, the adhesive replaces the joining by ply-bonding which is typically used in the production of toilet paper with smooth layers.

The layers fed to the counter-acting cylinder can be single, but it is also possible to provide for the feeding of a plurality of layers simultaneously. In this case, the adhesive can make the layers adhere to each other by penetrating between the fibers which form them. The penetration is facilitated by the pressure exerted by the pressure roller on the points in the lamination area.

According to a further aspect of the invention, a device is provided for producing a multiple-layer paper web material, comprising: a counter-acting cylinder provided with a plurality of points and interacting with an adhesive dispensing roller, a pressure roller and a laminating roller; a first feed path for at least a first layer which is fed to said counter-acting cylinder and to said adhesive dispensing roller; and a second feed path for at least a second layer which is joined to said at least one first layer between the counter-acting cylinder and the laminating roller. According to the invention, characteristically, the points on the counter-acting cylinder have a density and dimensions such that the technical and functional and/or aesthetic characteristics of the web material are not appreciably altered, and such that the two layers are joined by means of the adhesive applied by said dispensing roller only at the positions of the points.

In a different embodiment of the invention, a device is provided for producing the multiple-layer paper web material, comprising: a counter-acting cylinder interacting with an adhesive dispensing roller and a laminating roller; a first feed path for at least a first layer which is fed between said counteracting cylinder and said adhesive dispensing roller; and a second feed path for at least a second layer which is joined to said at least one first layer between the counter-acting cylinder and the laminating roller. Characteristically, the adhesive dispensing roller has a plurality of points for applying the adhesive to the first layer, while the cylindrical surface of the counter-acting cylinder is preferably smooth.

Further advantageous characteristics and embodiments of the method and device according to the invention are set forth in the attached claims.

The invention also relates to a multiple-layer paper sheet product comprising at least a first and at least a second layer joined together by gluing, characterized in that it has a plurality of gluing points which do not coincide with a decorative motif, if present. In practice, the paper product is essentially smooth at the gluing points, or has an embossing whose pattern does not necessarily coincide with the area of application of the adhesive. Further advantageous characteristics of the product according to the invention are indicated in the attached claims.

### BRIEF DESCRIPTION OF THE DRAWINGS

The invention will be more clearly understood from the description and the attached drawing which shows practical embodiments of the invention. More particularly, in the drawing,

FIG. 1 shows schematically and in a side view a first embodiment of a device according to the invention;

FIG. 1A shows an enlargement of a portion of the counter-acting cylinder of FIG. 1;

FIG. 2A shows in a highly enlarged and highly schematic view a cross section of a portion of web product obtained with the device of FIG. 1;

FIG. 2B shows the product of FIG. 2A after a possible calendering;

FIG. 3 shows a schematic cross section, highly enlarged, of a second web product which can be obtained with the device of FIG. 1;

FIG. 4 shows a highly enlarged view of the. area of lamination of the two layers;

FIG. 5 shows in a schematic side view a second embodiment of a device according to the invention;

FIG. 6 shows a schematic side view of a third embodiment of a device according to the invention;

FIG. 7 shows an enlargement of the detail indicated by VII in FIG. 5 and in FIG. 6;

FIG. 8 shows schematically and in a highly enlarged view the area of lamination of the device of FIG. 5 or of FIG. 6.

### DETAILED DESCRIPTION OF PREFERRED EMBODIMENTS OF THE INVENTION

With reference to FIGS. 1 to 4 initially, in a first embodiment the device according to the invention comprises a first counter-acting cylinder 1, rotating about an axis 1A and interacting with a first pressure roller 3 having an axis 3A parallel to the axis of the counter-acting cylinder 1, and with a laminating roller 5, having an axis 5A which is also parallel to the axis of the counteracting cylinder 1.

The counter-acting cylinder 1 also interacts with an adhesive distributor indicated in a general way by 7, and provided with an adhesive dispensing roller 9, which advantageously has a smooth surface, and which receives the adhesive from a screen roller 11 or the like, which in turn draws the adhesive from a distributor 12.

The cylindrical surface of the counter-acting cylinder 1 (consisting of steel or other hard material) is provided with a plurality of points 1 P shown, in particular, in the enlargement of FIG. 1A. The points 1P are very widely spaced, and their dimensions are small. Typically, the dimensions and density of the points are such that their surface occupies a percentage of 5% or less of the lateral surface of the cylinder, and preferably from 1% to 2% of the surface of the cylinder.

The pressure roller 3 and the laminating roller 5 are coated with very hard rubber layers, indicated by 3R and 5R respectively in the view of FIG. 1. The high degree of hardness of the coating of the pressure roller is such that the layers forming the web material which are fed around the counter-acting cylinder 1 and pressed against its surface by the rollers 3 and 5 undergo a very small degree of deformation, since the points 1P only penetrate to a small extent into the thickness of the coating of the rollers 3 and 5. In practice, the coating of the laminating roller can be made to have a hardness of 90-95 Shore A. The coating of the pressure roller 3 can vary from 80 to 90 Shore A, when the web material is smooth, and from 75 to 85 Shore A when the web material is pre-embossed, as described later on. The hardness can also vary to allow for the fact that the deformation of the web material also depends on the pressure between cylinder 1 and the rollers 3 and 5.

In the illustrated example, two pre-embossing units, indicated by 13 and 15 respectively, are located up-stream from the rollers 3 and 5. These units can also be omitted or made inoperative, according to the type of product required.

A first layer of paper material, indicated by V1, is fed along a first feed path to the device, and is run around the first pressure roller 3 and compressed between this and the counter-acting cylinder 1. A second layer V2 of paper material is fed along a second path, is positioned on top of the first layer and is laminated together with the first layer in the laminating nip between the counter-acting cylinder 1 and the laminating roller 5.

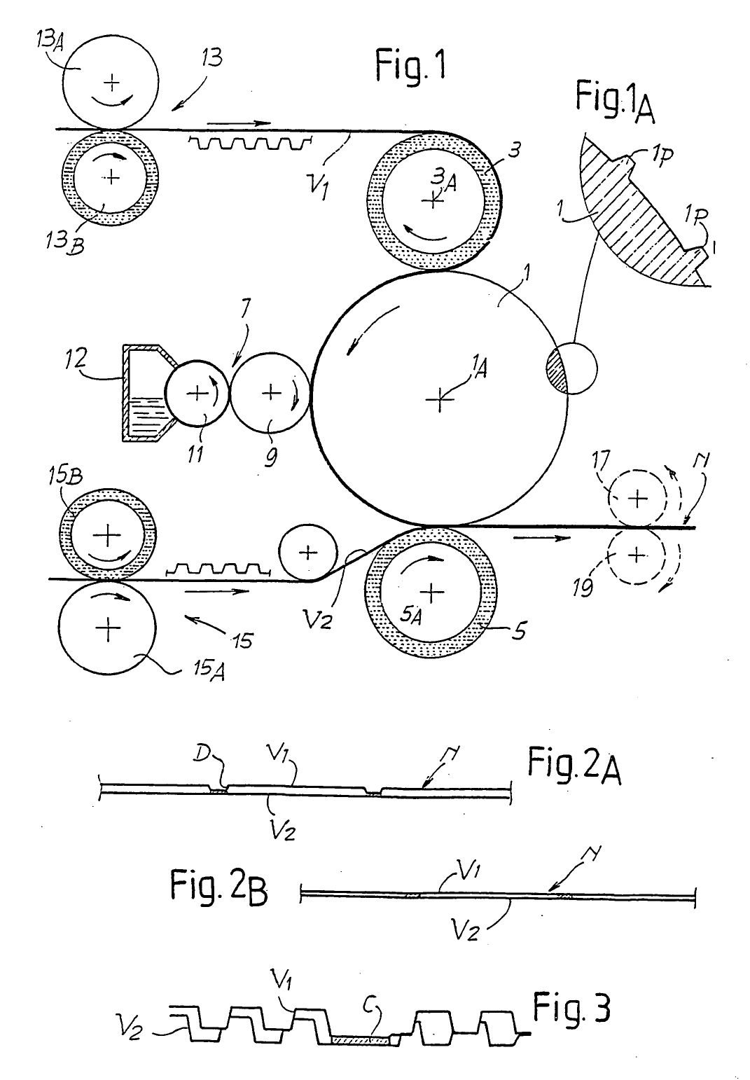

FIGS. 2A and 2B show the web product which can be produced by the device of FIG. 1 when the first and second embossing units 13 and 15 are disabled, in other words when the layers V1 and V2 pass through these units without undergoing any pre-embossing, or when these pre-embossing units are absent. In this case, the layer V1 undergoes a slight deformation, due to the action of the pressure roller 3, as indicated by D in FIG. 2A, at the location of the points 1P of the counter-acting cylinder 1. As mentioned above, the depth of the deformation D is very small, because of the hardness of the coating of the pressure roller 3 and/or the low pressure exerted between the roller 3 and the cylinder 1. Typically, the deformed area D projects by a few hundredths of a millimeter from the surface of the layer V1, for example by 0.02 to 0.3 mm, and preferably from 0.05 to 0.15 mm. The contact surface between the points 1P and the layer V1 can advantageously be equal to or less than 1.2 mm².

The adhesive C is applied by the adhesive dispensing roller 9 in these deformed areas. Because of the high degree of hardness of the pressure roller 3 and the small size of the points 1P of the counter-acting cylinder 1, the deformed areas D of the layer V1 are extremely small and practically imperceptible in the end product. The deformation in the areas D of the layer V1 can be eliminated completely by using, for example, a pair of small rollers 17 and 19, between which the layers V1 and V2 are made to pass after lamination between the counter-acting cylinder 1 and the laminating roller 5. FIG. 2B shows schematically the result of the flattening caused by the calendering between the small rollers 17 and 19 in the web material N consisting of the joined layers V1 and V2. The deformation of the layer could also be achieved by the reduction of the tension in the layer when this leaves the cylinder 1.

The flattening of the deformed areas D of the web material can also be achieved simply during the subsequent winding of the web material, for example when the material is used for the production of rolls of toilet paper, kitchen paper or the like.

When the pre-embossing units 13 and 15 are operational, the layers V1 and V2 are pre-embossed before they are fed to the counter-acting cylinder 1. In a known way, each of the pre-embossing units 13 and 15 has a cylinder of hard material, made from steel for example (indicated by 13A and 15A respectively) and a cylinder coated with a yielding material, for example rubber (indicated by 13B and 15B respectively).

The preembossing formed by the embossing units 13 and 15 can have a high density, for example more than 15 protuberances per cm², and even more preferably equal to or greater than 30 protuberances per cm²; in other words, it is a micro-embossing. The depth of the protuberances formed in the pre-embossing step can be variable, and typically of the order of several tenths of a millimeter. In order to prevent the pre-embossing formed by the embossing units 13 and 15 from being damaged by the passage of the layers between the rollers 3 and 5 and the counter-acting cylinder 1, the points 1P on the surface of the counter-acting cylinder are advantageously made with a sufficient height which is greater than the depth of the protuberances formed by the pre-embossing units 13 and 15.

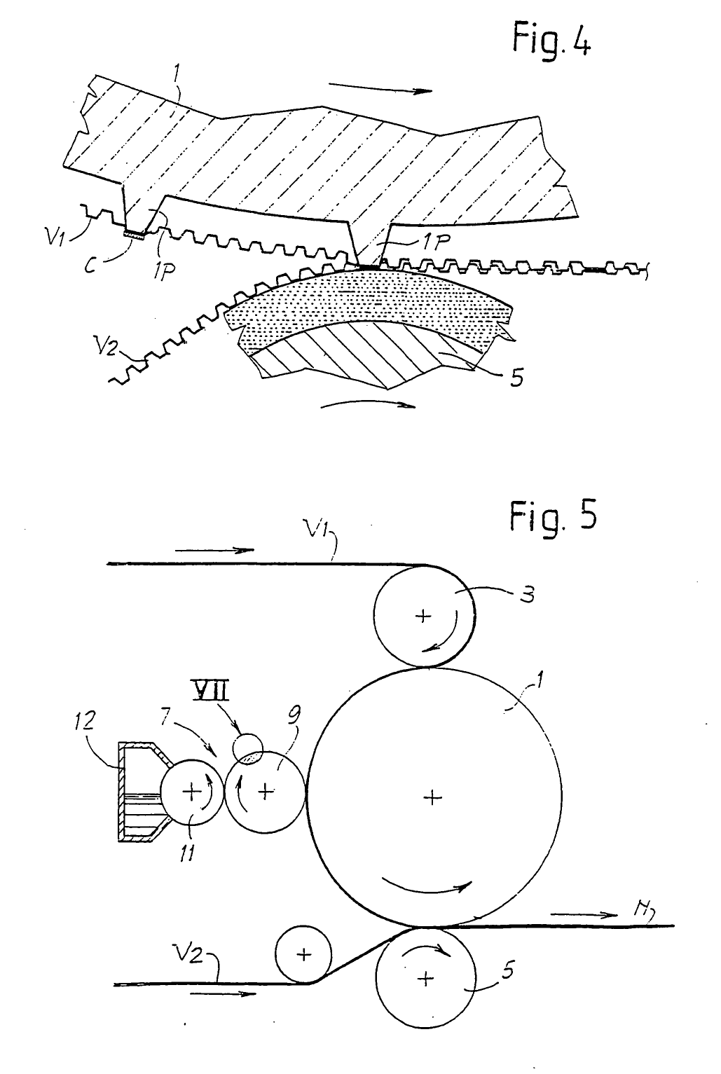

FIG. 3 shows in a highly schematic way the end product when the preembossing units 13 and 15 are operational. Each of the two layers V1 and V2 has a plurality of protuberances formed by the pre-embossing and are joined together by spots of adhesive C applied at the positions of the points 1P on the counter-acting cylinder 1. The dimensions and density of these points are such that they have no appreciable effect on the aesthetic and/or technical and functional properties of the end product. FIG. 4 shows the area of lamination between the laminating roller 5 and the counter-acting cylinder 1, where it can be seen that the height of the points 1P of the counter-acting cylinder 1 is sufficient to avoid damage to the embossing of the layers V1 and V2 during the lamination in the areas surrounding the points 1P. A similar situation is present for the layer V1 between the counter-acting cylinder 1 and the pressure roller 3.

FIGS. 5 to 8 show a different embodiment of the device according to the invention. With reference initially to FIGS. 5, 7 and 8, the device again has a counter-acting cylinder 1 interacting with a pressure roller 3 and with a laminating roller 5, which can be coated with rubber or other yielding material, of suitable hardness, or which can also be made with steel surfaces. In this case, the embossing cylinder 1 has a smooth cylindrical surface and interacts with an adhesive applicator 7 comprising an adhesive dispensing roller 9, a distributing roller 11 which for example may be screened, and a distributor 12. The adhesive dispensing roller 9 is provided with a plurality of points 9P (see FIG. 7 in particular) whose dimensions and density are essentially equivalent to those of the points 1P of the counter-acting cylinder 1 of FIG. 1. The references V1 and V2 indicate the first and second layers fed to the counteracting cylinder 1.

The layer V1, fed along a first feed path, is calendered at low pressure between the counter-acting cylinder 1 and the pressure roller 3 before it receives the adhesive C from the points 9P on the adhesive dispensing roller 9. In the nip formed between the laminating roller 5 and the counter-acting cylinder 1, the two layers V1 and V2 are joined by means of the adhesive C distributed in spots by the points 9P on the layer V1 (see FIG. 8 in particular) to produce the final web product N. The laminating roller 5 provides the necessary pressure to ensure that the adhesive grips the web material.

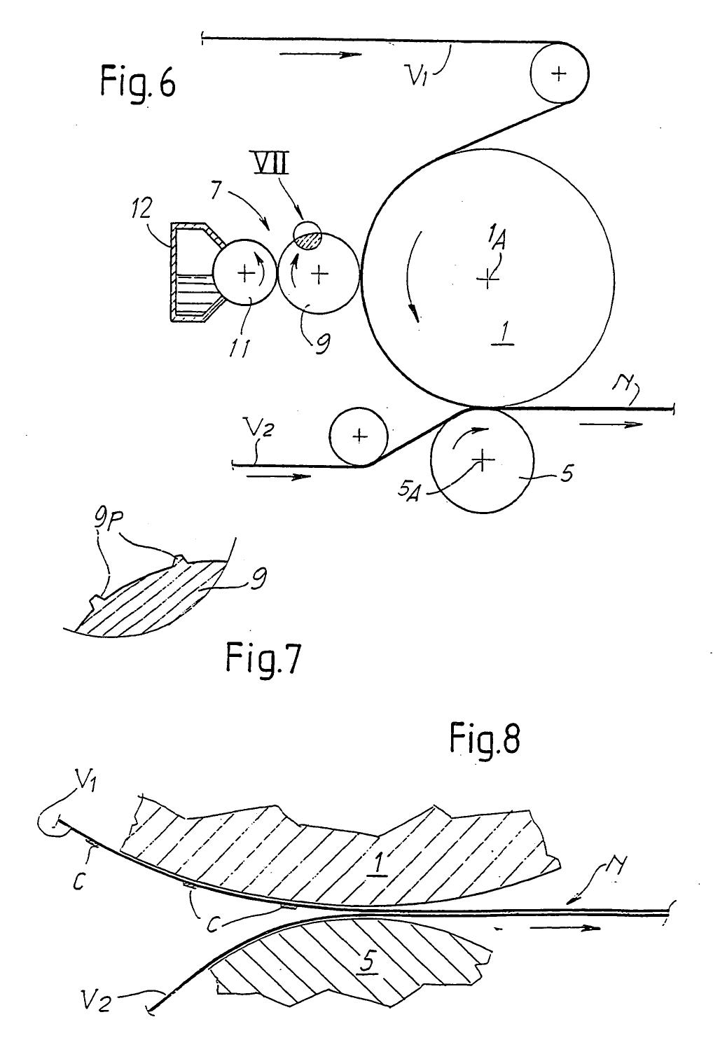

The embodiment of FIG. 6 differs from the embodiment of FIG. 5 solely in the absence of the pressure roller 3, so that the first layer V1 is not calendered before the application of the adhesive.

In the embodiments of FIGS. 5 to 8, the final web product N is essentially smooth and has the appearance shown in FIG. 2B, being flatted and laminated between the roller 5 and the counter-acting cylinder 1.

In this case also, each of the points 9P can have a surface area of approximately 1.2 mm² or less in contact with the layer V1.

It is to be understood that the drawing shows only some possible embodiments of the invention, which can be varied in its forms and arrangements without departure from the scope of the principle of the invention. The presence of any reference numbers in the attached claims is solely intended to facilitate the reading of the claims in the light of the preceding description and of the attached drawings, and does not limit the scope of protection of the claims.

1. A method for producing a multiple-layer paper web material, comprising the steps of: applying an adhesive to at least a first layer by passing said first layer between a counter-acting cylinder and an adhesive dispensing roller; placing next to said first layer at least a second layer in contact with the adhesive applied to the first layer, and laminating said at least a first and second layer, characterized in that said adhesive is applied in areas at the positions of the points with which the counter-acting cylinder or the adhesive dispensing roller is provided, the density and dimensions of these points being such that sufficient adhesion is provided between said at least two layers, but also such that the technical and functional and/or aesthetic characteristics of the web material are not appreciably altered.

2. The method according to claim 1, characterized in that the surface area of distribution of the adhesive delimited by said points is equal to or less than 5%, and preferably equal to or less than 2%, of the total surface area of the web material.

3. The method according to claim 1 or 2, characterized in that said points have a density of not more than 2 points per cm².

4. The method according to claim 1 or 2 or 3, characterized in that each of said points has a surface area of contact with the first layer not exceeding 1.2 mm².

5. The method according to one or more of claims 1 to 4, characterized in that said points are provided on the cylindrical surface of the counter-acting cylinder, a pressure roller is provided which interacts with said counter-acting cylinder, and said at least a first layer is deformed between the pressure roller and the counter-acting cylinder up-stream from said adhesive dispensing roller.

6. The method according to claim 5, characterized in that said first layer is deformed to generate on it protuberances having a height in the range from 0.02 to 0.3 mm, and preferably in the range from 0.05 to 0.15 mm.

7. The method according to one or more of the preceding claims, characterized in that at least one of said layers is pre-embossed with a pattern comprising at least one set of protuberances, and in that said points have a height which is sufficient to avoid the flattening of the protuberances forming said decorative pattern.

8. The method according to claim 7, characterized in that said embossed decorative pattern is formed with a density of protuberances of more than 15 protuberances per cm² and preferably in the range from 30 to 100 protuberances per cm².

9. The method according to one or more of the preceding claims, characterized in that said points are positioned on the adhesive dispensing roller and an essentially smooth cylindrical surface is provided on said counter-acting cylinder.

10. The method according to claim 9, characterized in that said at least one first layer is calendered between the counter-acting cylinder and a pressure roller interacting with it up-stream from the application of the adhesive.

11. A device for producing a multiple-layer paper web material, comprising: a counter-acting cylinder provided with a plurality of points and interacting with an adhesive dispenser, a pressure roller and a laminating roller; a first feed path for at least a first layer which is fed between said counter-acting cylinder and said adhesive dispensing roller; and a second feed path for at least a second layer which is joined to said at least one first layer between said counter-acting cylinder and said laminating roller, characterized in that said points on the counter-acting cylinder have a density and dimensions such that the technical and functional and/or aesthetic characteristics of the web material are not appreciably altered, and such that the two layers are joined by means of the adhesive applied by said dispensing roller at the positions of said points.

12. The device according to claim 11, characterized in that said points form an adhesive application surface equal to or less than 5% and preferably equal to or less than 2% of the total surface area of the lateral surface of the counter-acting cylinder.

13. The device according to claim 11 or 12, characterized in that said pressure roller has a yielding cylindrical surface whose hardness is such that, when it is pressed against said counter-acting cylinder with said first layer positioned between the embossing cylinder and the pressure roller, it generates in the layer a set of protuberances whose height is in the range from 0.02 to 0.3 mm and preferably from 0.05 to 0.15 mm.

14. The device according to claim 10, 11 or 12, characterized in that it comprises at least a first pre-embossing unit for pre-embossing at least said first or said second layer, up-line from said counter-acting cylinder.

15. The device according to claim 14, characterized in that it comprises a second pre-embossing unit for said second or said first layer, upstream from said counter-acting cylinder.

16. The device according to claim 14 or 15, characterized in that said first and, if present, said second pre-embossing unit generate an embossing pattern with a density of more than 15 protuberances per cm² and preferably in the range from 30 to 100 protuberances per cm².

17. The device according to claim 14, 15 or 16, characterized in that the points on said counter-acting cylinder have a height greater than the height of the protuberances generated on the first and/or on the second layer by said first and, if present, by said second pre-embossing unit.

18. The device according to. one or more of claims 11 to 17, characterized in that each of said points of the counter-acting cylinder has an end surface area of not more than 1.2 mm².

19. The device according to one or more of claims 11 to 18, characterized in that said points are positioned with a density of not more than 2 points per cm².

20. A device for producing a multiple-layer paper web material, comprising: a counter-acting cylinder interacting with an adhesive dispensing roller and a laminating roller; a first feed path for at least a first layer which is fed between said counter-acting cylinder and said adhesive dispensing roller; and a second feed path for at least a second layer which is joined to said at least a first layer between the counter-acting cylinder and said laminating roller; characterized in that said adhesive dispensing roller has a plurality of points for applying said adhesive to the first layer.

21. The device according to claim 20, characterized in that said counter-acting cylinder has a smooth cylindrical surface.

22. The device according to claim 20 or 21, characterized in that said points on the adhesive dispensing roller have a density and dimensions such that the glued surface of the two layers is equal to or less than 5% and preferably equal to or less than 2% of the total surface area of the web material.

23. The device according to claim 20 or 21 or 22, characterized in that said points are positioned with a density of not more than 2 points per cm².

24. The device according to one or more of claims 20 to 23, characterized in that each of said points has an end surface equal to or less than 1.2 mm².

25. A multiple-layer paper sheet product, comprising at least a first and at least a second layer joined together by gluing, characterized in that it has a plurality of gluing points which do not coincide with an embossed decorative pattern.

26. The product according to claim 25, characterized in that said gluing points have a density and dimensions such that the glued surface of the layers is equal to or less than 5% and preferably equal to or less than 2% of the total surface area of the layers.

27. The product according to claim 25 or 26, characterized in that said two layers are essentially non-embossed.

28. The product according to claim 25 or 26, characterized in that at least one of the layers is embossed.

29. The product according to claim 28, characterized in that both of the layers are embossed.

30. The product according to claim 28 or 29, characterized in that said layer or layers have an embossing comprising a plurality of protuberances with a density of more than 15 protuberances per cm² and preferably more than 30 protuberances per cm².

31. The product according to one or more of claims 25 to 30, characterized in that said gluing points are distributed with a density of not more than 2 points per cm².
